(19) United States
(12) Patent Application Publication
(10) Pub. No.: US 2007/0138200 A1
(43) Pub. Date: Jun. 21, 2007

(54) Disc-discharging apparatus

(76) Inventor: Shu-Yuan Lee, Panchiao City (TW)

Correspondence Address: CHARLES E. BAXLEY, ESQ., 90 JOHN STREET, THIRD FLOOR, NEW YORK, NY, 10038, US

(21) Appl. No.: 11/305,319

(22) Filed: Dec. 19, 2005

(51) Int. Cl. B23Q 7/04

(52) U.S. Cl. 221/208

(57) ABSTRACT

A disc discharging apparatus comprises a body, a first pushing portion and a second pushing portion. The body includes a through hole and a recess, in an edge of the through hole is formed a limit groove, and in the recess are formed a plurality of opposite limit portions, a discharging slot is defined in the body and is in communication with the recess. The first pushing portion and the second pushing portion are integrally connected with each other to form a pusher, the pusher has a through hole and is slideably disposed between the through hole and the recess of the body, and on an inner wall of the through hole of the pusher are formed a plurality of opposite pushing portions.

### BACKGROUND OF THE INVENTION

1. Field of the Invention

The present invention relates to a disc discharging apparatus, and more particularly to a disc discharging apparatus, wherein the discs are discharged in a first in first out manner.

2. Description of the Prior Art

Optical disc has found a wide application, for example, video/audio disc and data disc, and it also can be used as a memory medium for storage of company or personal data.

The existing disc discharging method generally involves a mechanical arm mainly consisted of a connecting rod assembly, a suction disc and other component, wherein the suction disc is employed to hold the optical disc, and then the mechanical arm is used to transport it to a predetermined position. However, this conventional disc discharging method still has the following disadvantages that need to be improved:

First, since the connecting structure between the connecting rod assembly and the suction disc is complicated, and it also requires many control circuits, therefore, the resultant cost is relatively high.

Second, the conventional discharging procedure is complicated and includes many steps, such sucking, transporting, and releasing, therefore, the conventional discharging method is time consuming and has a long working travel, imperceptibly increasing the production cost.

Third, the conventional disc discharging apparatus is complicated and expensive, therefore, it is usually used in factory and is unsuitable for commercial and personal use.

Usually, a company or an individual will use optical discs as a medium for preservation of data, and most of the discs are stored in a disc container. The user has to open the container, taking out the disc, and then close the container again, so it is really inconvenient.

In addition, when the discs are nearly used up and the container needs to be refilled with new discs, based on the principle of first in first out, the user has to take out the original discs, putting the new discs in, and finally put the original discs back into the disc container. This is an obvious inconvenience to the user.

The present invention has arisen to mitigate and/or obviate the afore-described disadvantages.

### SUMMARY OF THE INVENTION

The primary objective of the present invention is to provide a disc discharging apparatus whose structure is simplified.

The secondary objective of the present invention is to provide a low cost disc discharging apparatus.

Another objective of the present invention is to provide a disc discharging apparatus, wherein the discs can be discharged more quickly.

Yet, another objective of the present invention is to provide an easily operated disc discharging apparatus.

The present invention will become more obvious from the following description when taken in connection with the accompanying drawings, which show, for purpose of illustrations only, the preferred embodiments in accordance with the present invention.

### BRIEF DESCRIPTION OF THE DRAWINGS

FIG. 1 is an exploded view of a disc discharging apparatus in accordance with a first embodiment of the present invention;

FIG. 2 is a partial cross sectional view of the disc discharging apparatus in accordance with the present invention;

FIG. 3 is another partial cross sectional view of the disc discharging apparatus in accordance with the present invention;

FIG. 4-6 is an operational view of the disc discharging apparatus in accordance with the present invention;

FIG. 7 is another exploded view of a disc discharging apparatus in accordance with another embodiment of the present invention; and

FIG. 8 and 9 is another operational view of the disc discharging apparatus in accordance with another embodiment of the present invention.

### DETAILED DESCRIPTION OF THE PREFERRED EMBODIMENTS

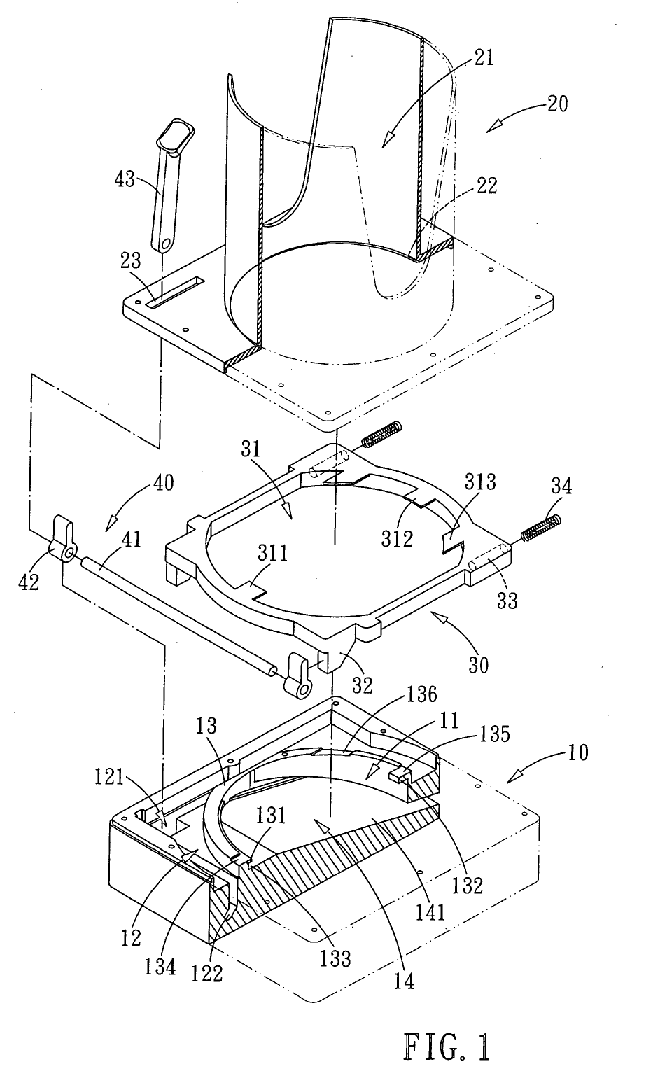

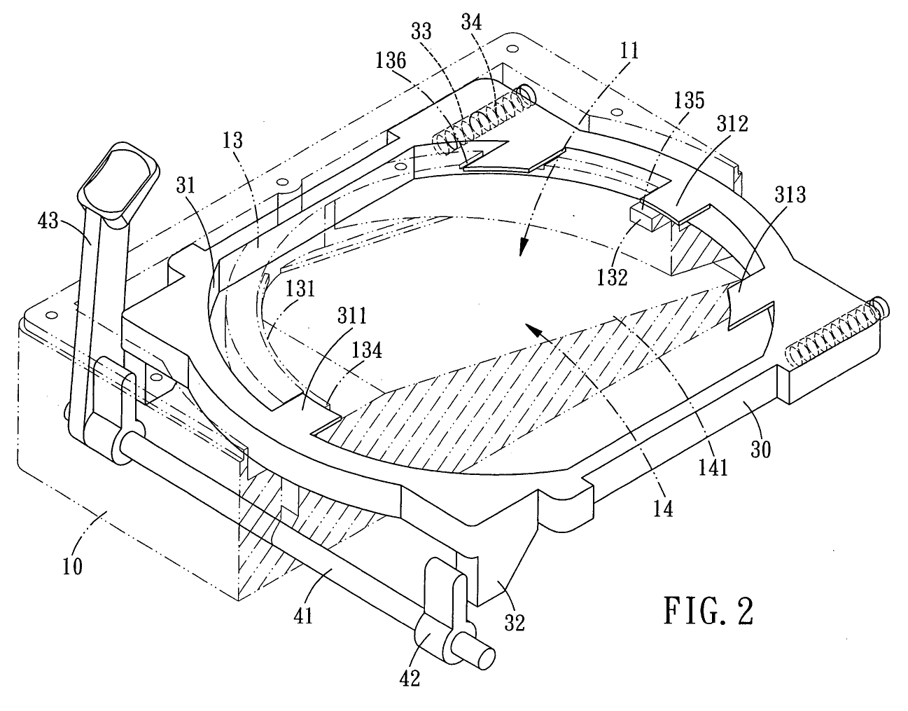

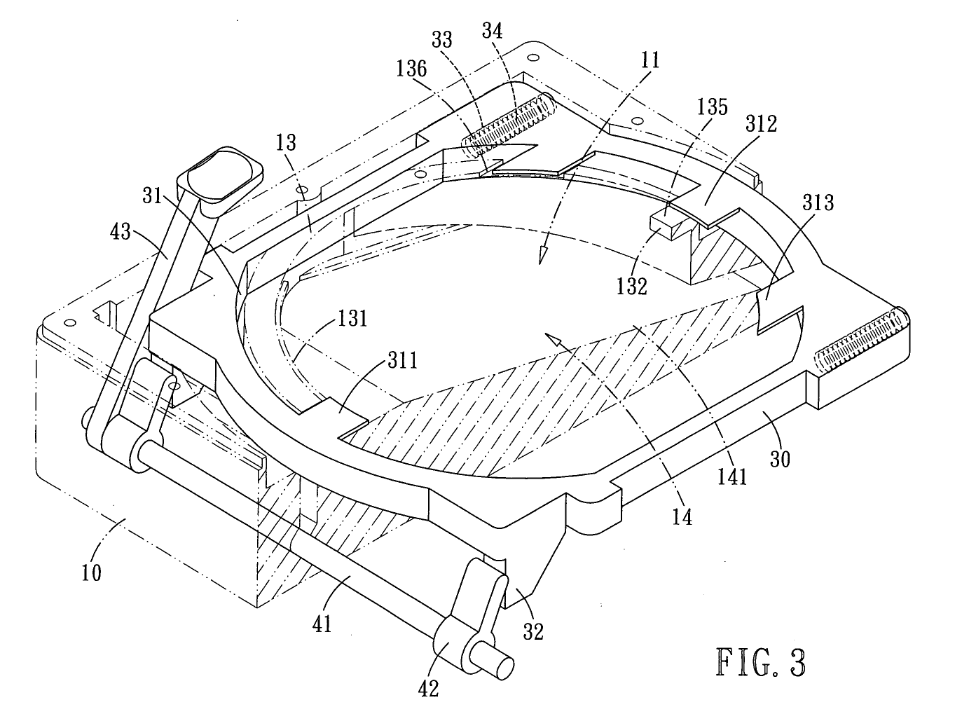

Referring to FIGS. 1-3, a disc discharging apparatus in accordance with the present invention comprises a body consisted of a supporting base 10 and a disc storage base 20, and in the body are installed a pusher 30 and a driving assembly 40.

The supporting base 10 is formed in the surface thereof with a recess 11 and a frame-shaped sliding groove 12. Around the edge of the recess 11 is formed an annular flange 13, and on opposite sides of the annular flange 13 are defined two outward protruding limit portions 131 and 132. The shortest distance between the two limit portions 131 and 132 is smaller than the diameter of the disc A, so that the disc A can be positioned on the limit portions 131 and 132. The limit portion 131 is arc-shaped, below the limit portion 131 is a groove 133, and the limit portions 131 and 132 each formed with a notch 134, 135. In the flange 13 is formed two auxiliary notches 136. A discharging slot 14 is defined in the supporting base 10 and connected with the recess 11. The entrance of the discharging slot 14 is located at a side of the supporting base 10, and the bottom of the discharging slot 14 is a slant discharging surface 141. Two cavities 121 are defined in the sliding groove 12, and between the cavities 121 is a pivotal groove 122.

The disc storage base 20 is in the shape of a column for containing the disc A and is fixed on the supporting base 10 by screws. A through hole 21 is formed in the disc storage base 20 and is aligned to the recess 11 of the supporting base 10 for passage of the disc A. A limit groove 22 is defined in the edge of the through hole 21, and an actuating-member-receiving hole 23 is defined in the disc storage base 20 and located correspondingly to one of the cavities 121 of the supporting base 10. In addition, the limit portions 131 and 132 will protrude out of the inner wall of the through hole 21 of the storage base 20.

The pusher 30 is a frame structure formed with a through hole 31 and is located between the supporting base 10 and the disc storage base 20 in such a manner that the pusher 30 is slideably received in the sliding groove 12 of the supporting base 10. At a side of the bottom of the pusher 30 are formed two legs 32 to be received in the cavities 121 of the sliding groove 12, and in another side of the bottom of the pusher 30 are formed two receiving holes 33. Each of the receiving holes -33 is installed with an elastic member 34 (such as spring) in such a manner that one end of the elastic member 34 abuts against the bottom of the receiving hole 33, and the other end of the elastic member 34 presses against the wall of the sliding groove 12 of the supporting base 10. On the inner edge of the through hole 31 of the pusher 30 are formed two pushing portions 311 and 312 that extend toward the center of the through hole 31, and are further formed two auxiliary pushing portions 313. The pushing portions 311 and 312 will be slideably received in the notches 134 and 135 of the supporting base 10, and the auxiliary pushing portions 313 is to be slideably received in the auxiliary notches 136. The distance between the pushing portions 311 and 312 is right large enough for passage of the disc A.

The driving assembly 40 includes a shaft 41, two pushing elements 42 and a controlling rod 43 and is to be assembled on the supporting base 10. The shaft 41 is disposed in the pivotal groove 122, the pushing elements 42 are located in the cavities 121, one end of the controlling rod 43 is received in the cavities 121, and another end of the controlling rod 43 passes through the actuating-member-receiving hole 23 of the disc storage base 20 so as to be operated by the user.

According to the abovementioned disc discharging apparatus, the pusher is disposed in the disc receiving space, and plus the limit portions and the driving assembly, the optical disc can be discharged according to operation, thus simplifying the disc discharging apparatus.

Besides, according to the abovementioned disc discharging apparatus, the pusher is disposed in the disc receiving space, and plus the limit portions and the driving assembly, these make the disc discharging apparatus has a simplified structure. Thus, the production cost is reduced.

Furthermore, according to the abovementioned disc discharging apparatus, the pusher is disposed in the disc receiving space, and plus the limit portions and the driving assembly, these arrangements can reduce the time for disc discharging and can reduce the production cost.

In addition, according to the abovementioned disc discharging apparatus, the pusher is disposed in the disc receiving space, and plus the limit portions and the driving assembly, the disc discharging apparatus is unsuitable for commercial and personal use.

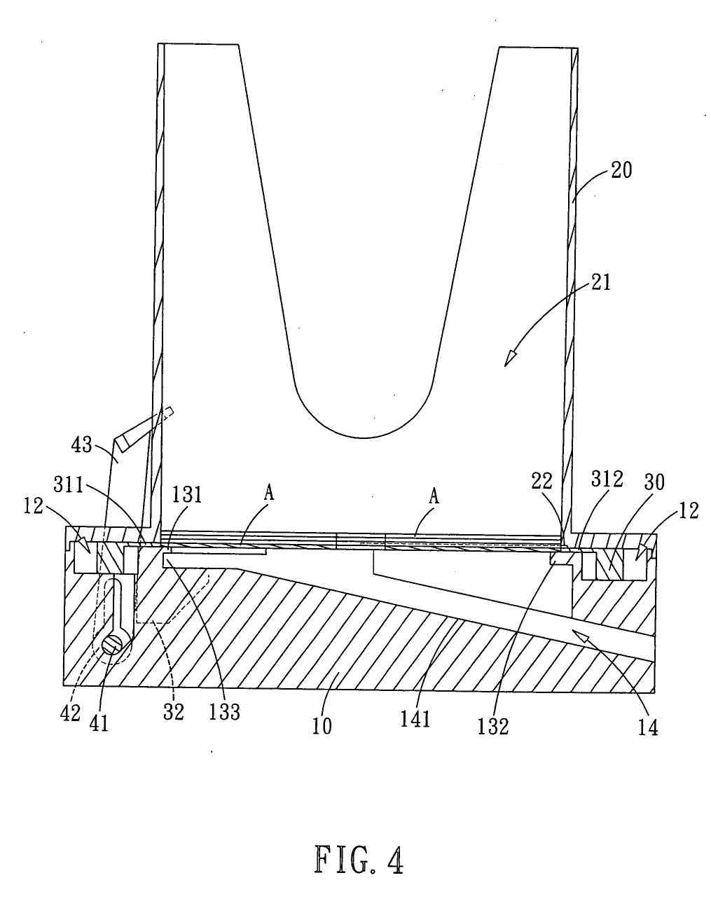

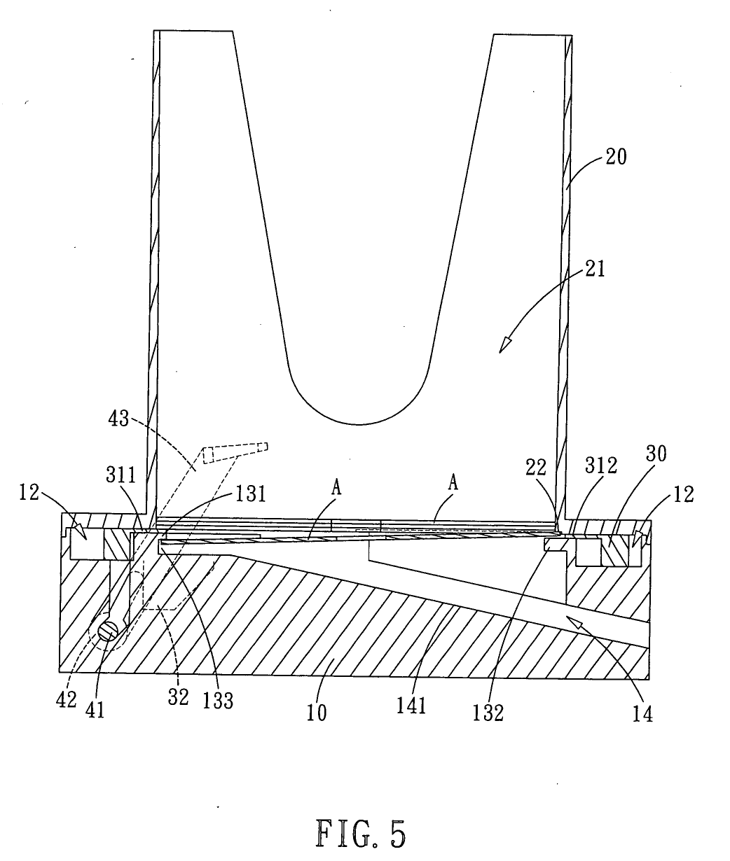

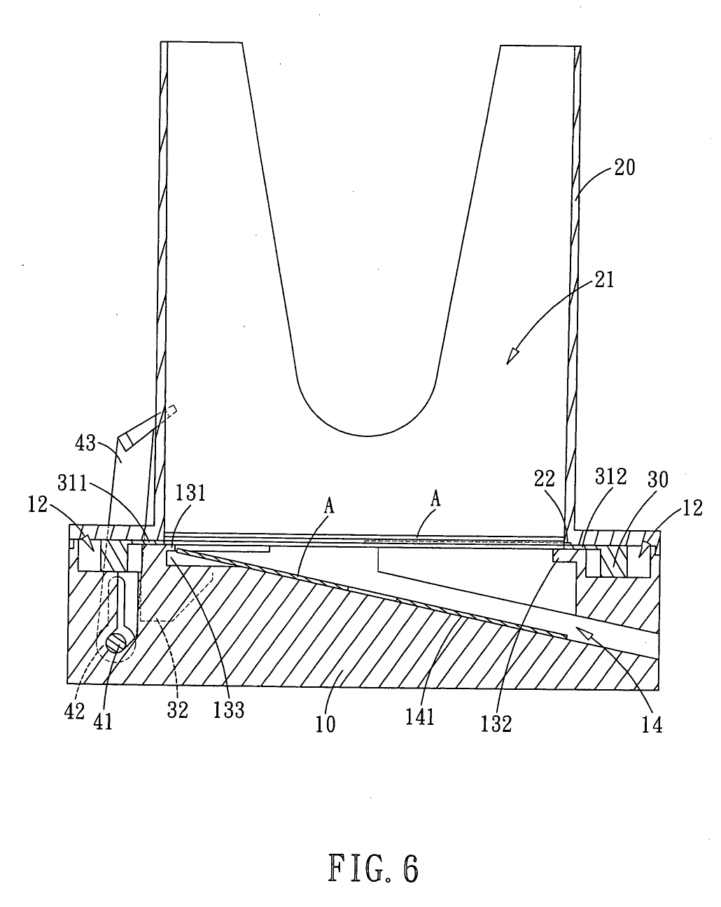

For a better understanding of the present invention, its operation and function, reference should be made further to FIGS. 1-6, when user pushes the controlling rod 43 of the driving assembly 40, the pushing element 42 will be caused to rotate a certain angle around the shaft 41, and then the pushing element 42 will push the legs 32, so that the pusher 30 will be caused to slide in the sliding groove 12 of the supporting base 10.

At this moment, an end of the disc A on the limit portions 131, 132 of the supporting base 10 will be pushed by the pushing portion 311 of the pusher 30. The pushing portion 311 will slide in the sliding groove 134 of the supporting base 10. This end of the disc A will fall into the groove 133 of the supporting base 10 after it is pushed out of the limit portion 131 by the pushing portion 311, and the other end of the disc A is still positioned on the limit portion 132 and is restricted by the limit groove 22. At this movement, the disc A is in an inclined position. Furthermore, when the pusher 30 is sliding in the sliding groove 12 of the supporting base 10, the elastic member 34 of the pusher 30 will be compressed by the wall of the sliding groove 12 of the receiving hole 33 and the sliding groove 12 of the supporting base 10.

When the user releases the controlling rod 43, the elastic member 34 will be decompressed and so as to push the pusher 30 back to its original position. When the pusher 30 moves back, the pushing portion 312 and the auxiliary pushing portion 313 of the pusher 30 will slide in the notch 135 and the auxiliary notch 136 of the supporting base 10, so as to push the disc A out of the flange 132. And as a result, the disc A will fall into the discharging slot 14 of the supporting base 10. Since the discharging surface 141 is inclined downwardly outwardly, the disc A will be discharged successfully.

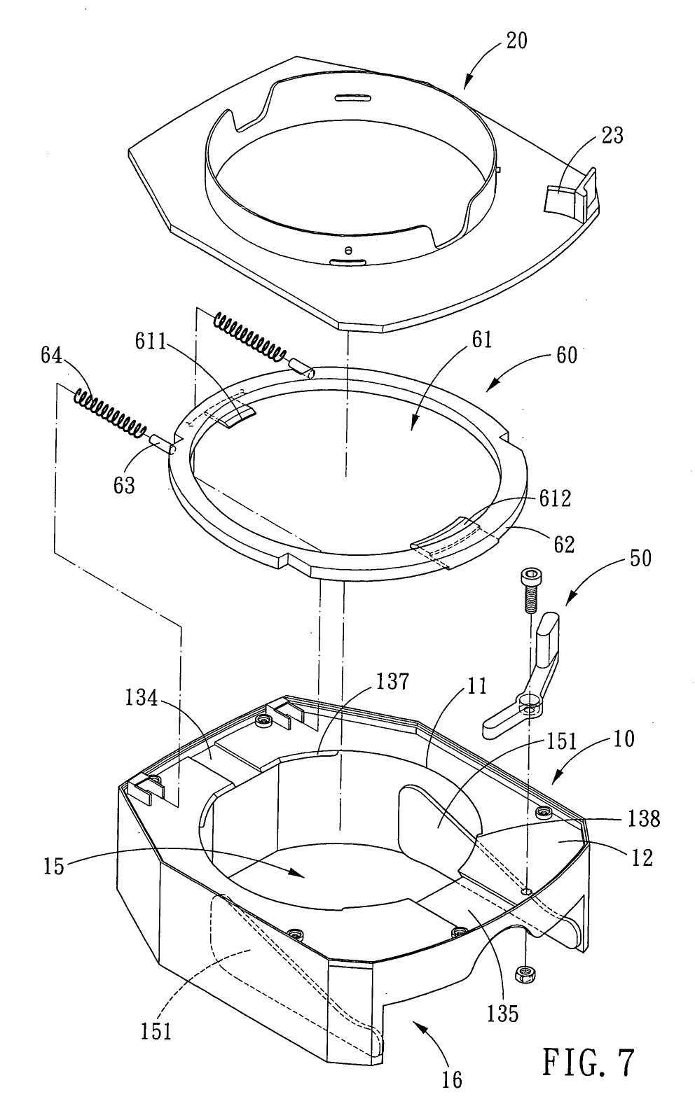

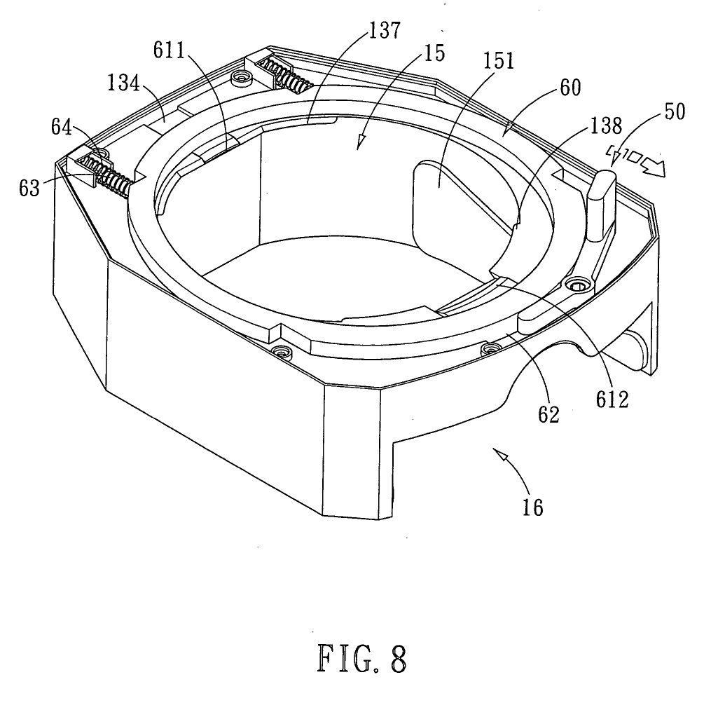

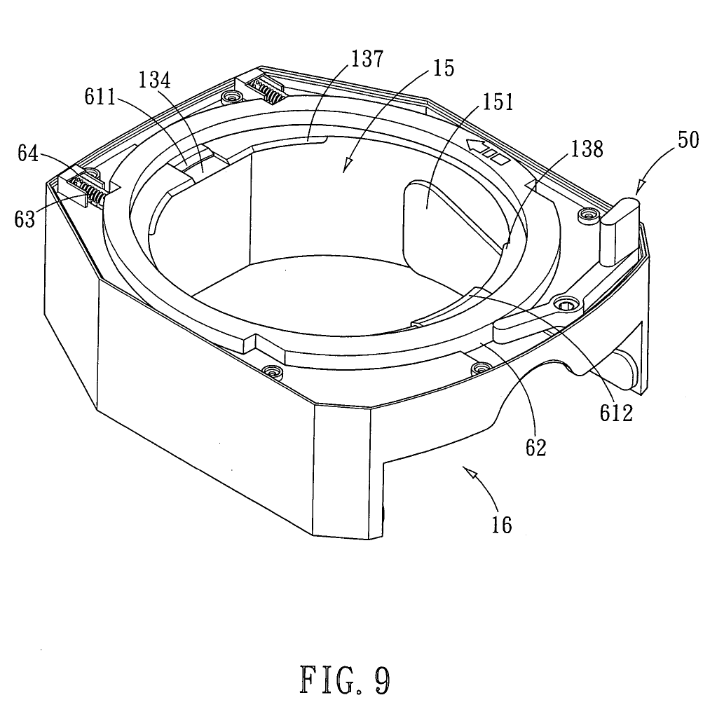

Referring to FIGS. 7-9, which shows another embodiment of the present invention, when the user pushes the controlling rod 50, the controlling rod 50 will be caused to push an edge 62 of a pusher 60, so that the pusher 60 will move in the sliding groove 12 of the supporting base 10.

At this moment, the disc A was originally positioned above the limit portions 137, 138 of the supporting base 10 and the pushing portion 611 of the pusher 60 will fall onto the limit portion 137 (the limit portion 137 is inclined toward the discharging slot 15), and will be supported by the lower portion of the inclined surface of the limit portion 137 and the limit portion 138. As the controlling rod 50 is being pushed, the pushing portion 612 will push the disc A out of the limit portion 138, so that the disc A will move along the inclined surface of the limit portion 137 and finally fall into the discharging slot 15. At both sides of the discharging slot 15 are arranged two discharging guide elements 151, and the top edge of the discharging guide elements 151 are inclined toward the discharging hole 16 and gradually become horizontal behind the discharging hole 16), so that the disc A can be introduced by the discharging guide elements 151 to the discharging hole 16. After the user releases the controlling rod 50, the elastic member 64 will push the pusher 60 back to original position.

In addition, in this invention, the pusher can be arranged in a comparatively complicated fashion and is called pushing assembly that has the same function as the pusher. For example, the pushing assembly can be consisted of a first pushing member and a second pushing member that are linked to each other and each has a pushing portion.

Moreover, in this invention, the driving assembly (or the actuating member of the controlling rod) and the elastic member disposed at a side of the pusher can form an actuating assembly.

It will be noted that since the limit portions 131, 132 of the supporting base 10 or the discs A protrude out of the inner wall of the through hole 21 of the disc storage base 20, plus the special position relationship between the limit portions 137, 138 and the pushing portions 611, 612, the disc A will be unable to pass through the through hole 21 if the user doesn't pull the controlling rod. In other words, the disc A will be kept in the discharging apparatus.

Furthermore, when the pushing portion 311 of the pusher 30 pushes the disc A, only an end of the disc A will fall into the groove 133 of the supporting base 10, meanwhile, the pushing portion 311 will also move to the lower edge of the through hole 21 so as to stop the next disc A. Another end of the disc A already fallen into the groove 133 will be positioned on the limit portion 132 and is restricted by the limit groove 22. Therefore, till now, no disc A will fall out of the disc discharging apparatus.

In addition, in the first embodiment, the distance between the limit groove 22 of the storage base 20 and the limit portion 132 of the pusher 30 is smaller than the thickness of two stacked discs A but is larger than the thickness of a single disc A. And in the second embodiment, the limit portions 137 and 138 are positioned such that only a single disc A can pass through the space therebetween.

When the discs A in the storage base 20 are gonging to be used up, additional discs A to be added can be stacked on the original discs A left in the storage base 20 because the discs A are discharged in such an order that the lowest disc A will be discharged ahead of the other discs A. Therefore, first in first out can be achieved.

While we have shown and described various embodiments in accordance with the present invention, it should be clear to those skilled in the art that further embodiments may be made without departing from the scope of the present invention.

What is claimed is:

1. A disc discharging apparatus comprising:
a supporting base, including a recess passing through the supporting base and a sliding groove formed between a peripheral edge of the recess and the supporting base;
a pushing assembly slideably arranged in the sliding groove of the supporting base, including a first pushing member linked with a second pushing member, on a surface of each of the first pushing member and the second pushing member facing the recess is formed a pushing portion, respectively;
an actuating assembly including an actuating member and at least one elastic member, the actuating member is pivotally disposed in the sliding groove of the supporting base and in contact with the pushing assembly, the at least one elastic member is arranged in a sliding direction of the pushing assembly and connected between the pushing assembly and a wall of the sliding groove of the supporting base; and
a disc storage base including a disc storage space and an actuating-member-receiving hole, the disc storage disposed on the supporting base and covers the pushing assembly, and the actuating member partially protrudes out of the actuating-member-receiving hole.

2. The disc discharging apparatus as claimed in claim 1, wherein the first pushing member and the second pushing member of the pushing assembly are integral with each other to form an annular pusher, and the pushing portion of the first pushing member and that of the second first pushing member are oppositely arranged and extend from an inner wall of the pushing members toward the inner center thereof.

3. The disc discharging apparatus as claimed in claim 1, wherein the actuating member of the actuating assembly includes a controlling portion formed on an end of a pushing portion thereof, the pushing portion is located in the sliding groove of the supporting base and arranged between the pushing assembly and the wall of the sliding groove, and the controlling portion is inserted in the actuating-member-receiving hole of the supporting base.

4. The disc discharging apparatus as claimed in claim 1, wherein the actuating member includes a shaft, at least one pushing element and a controlling rod, the shaft is disposed in the sliding groove of the supporting base, the at least one pushing element is located in the sliding groove of the supporting base and mounted on both ends of the shaft and presses against the pushing assembly, and a part of the controlling rod is arranged in the sliding groove of the supporting base, this part of the controlling rod is mounted onto the shaft, a base of the controlling rod is inserted in the actuating-member-receiving hole of the supporting base and protrudes out of the supporting base.

5. The disc discharging apparatus as claimed in claim 1, wherein two opposite protruding limit portions are formed on a peripheral edge of the recess of the supporting base.

6. The disc discharging apparatus as claimed in claim 1, wherein at least one notch is formed in the sliding groove of the supporting base for mating with the two pushing portions of the pushing assembly, so that the two pushing portions are slideably received in the at least one notch.

7. The disc discharging apparatus as claimed in claim 1, wherein the supporting base is defined with a discharging hole located in the sliding direction of the pushing assembly.

8. The disc discharging apparatus as claimed in claim 1, wherein a slant discharging surface is formed on a bottom of the recess, and the slant discharging surface is inclined from the recess toward the discharging hole.

9. The disc discharging apparatus as claimed in claim 8, wherein two discharging guide elements are provided in the supporting base located correspondingly to the recess, and the two discharging guide elements are arranged at two opposite sides of the supporting base and are inclined from the recess toward the discharging hole.
